(19) United States
(12) Patent Application Publication
(10) Pub. No.: US 2012/0005613 A1
(43) Pub. Date: Jan. 5, 2012

(54) CREATING AND MANAGING LOCATION BASED MEETINGS

(75) Inventors: Patrick Joseph O'Sullivan, Dublin (IE); Carol Sue Zimmet, Boxborough, MA (US); Ruthie D. Lyle, Durham, NC (US); Fred Raguillat, Meath (IE); Sean Callanan, Dublin (IE)

(73) Assignee: International Business Machines Corporation, Armonk, NY (US)

(21) Appl. No.: 12/827,309

(22) Filed: Jun. 30, 2010

(51) Int. Cl. G06F 15/173; G06F 3/048

(52) U.S. Cl. 715/772; 709/226

(57) ABSTRACT

A method and computer program product for creating and managing location based meetings is described. A method may comprise creating a local meeting entry, the local meeting entry referencing a global meeting entry in a different location. The method may further comprise propagating a schedule change in the global meeting entry to the local meeting entry. The method may also comprise rescheduling a resource reserved for the local meeting entry based upon, at least in part, the schedule change in the global meeting entry.

### BACKGROUND OF THE INVENTION

This disclosure relates to creating and managing location based meetings and, more particularly, to methodologies for managing schedule changes and resources reserved for location based meetings.

People in an organization may have meetings with colleagues in other locations. Meeting times may be adjusted to each location's local time. Users of calendar and scheduling applications may associate different resources to a meeting such as a room, projector, and/or other resources. These resources may often be dependent on location. When a user receives an invitation for a meeting from colleagues in a different location, the invitation may include information about the meeting room in the different location. The user may then need to book a meeting room, projector, and/or other resources locally. If the meeting time is changed, the user may then need to rearrange a meeting time in a meeting entry, or manually reschedule meeting resources including, but not limited to, booking of the meeting room and/or a projector. Accordingly, there may be a need to improve ways to create and manage meetings across multiple locations.

### BRIEF SUMMARY OF THE INVENTION

In a first embodiment, a method may comprise creating, via at least one of a client electronic device and a server computer, a local meeting entry, the local meeting entry referencing a global meeting entry in a different location. The method may further comprise propagating, via at least one of the client electronic device and the server computer, a schedule change in the global meeting entry to the local meeting entry. The method may also comprise rescheduling, via at least one of the client electronic device and the server computer, a resource reserved for the local meeting entry based upon, at least in part, the schedule change in the global meeting entry.

One or more of the following features may be included. Meeting information may be inherited from the global meeting entry to the local meeting entry. The global meeting entry and the local meeting entry may be displayed, wherein the local meeting entry may include a local meeting entry identifier. The global meeting entry may be accepted automatically, based upon, at least in part, acceptance of the local meeting entry. A global meeting entry creator and a local meeting entry creator may both receive the acceptance of the local meeting entry.

In some implementations, the method may further comprise removing the global meeting entry from display upon acceptance of the local meeting entry. The method may also comprise restricting access to global meeting entries and local meeting entries, wherein restricting access includes allowing only invitees of the global meeting entry to be invited to the local meeting entry. The resource reserved for the global meeting entry may be required for the local meeting entry. The method may further comprise selecting an alternative resource if the original resource reserved is no longer available for a new meeting time based upon, at least in part, the schedule change. Moreover, the method may comprise restricting alternative resources available to be selected if the original resource is no longer available for the new meeting time. The method may additionally comprise dynamically updating the local meeting entry based upon, at least in part, a location of the local meeting entry. A global meeting entry creator may be notified if at least one of a local meeting entry creator declines the local meeting entry, the local meeting entry creator delegates the local meeting entry; and the local meeting entry is not scheduled.

In a second embodiment, a computer program product may reside on a computer readable storage medium and may have a plurality of instructions stored on it. When executed by a processor, the instructions may cause the processor to perform operations comprising, creating a local meeting entry, the local meeting entry referencing a global meeting entry in a different location. The operations may further comprise propagating a schedule change in the global meeting entry to the local meeting entry. The operations may also comprise rescheduling a resource reserved for the local meeting entry based upon, at least in part, the schedule change in the global meeting entry.

One or more of the following features may be included. Meeting information may be inherited from the global meeting entry to the local meeting entry. The global meeting entry and the local meeting entry may be displayed, wherein the local meeting entry may include a local meeting entry identifier. The global meeting entry may be accepted automatically, based upon, at least in part, acceptance of the local meeting entry. A global entry meeting creator and a local meeting entry creator may both receive the acceptance of the local meeting entry.

In some implementations, the operations may further comprise removing the global meeting entry from display upon acceptance of the local meeting entry. The operations may also comprise restricting access to global meeting entries and local meeting entries, wherein restricting access includes allowing only invitees of the global meeting entry to be invited to the local meeting entry. The resource reserved for the global meeting entry may be required for the local meeting entry. The operations may further comprise selecting an alternative resource if the original resource reserved is no longer available for a new meeting time based upon, at least in part, the schedule change. Moreover, the operations may comprise restricting alternative resources available to be selected if the original resource is no longer available for the new meeting time. The operations may additionally comprise dynamically updating the local meeting entry based upon, at least in part, a location of the local meeting entry. A global meeting entry creator may be notified if at least one of a local meeting entry creator declines the local meeting entry, the local meeting entry creator delegates the local meeting entry; and the local meeting entry is not scheduled.

The details of one or more implementations are set forth in the accompanying drawings and the description below. Other features and advantages will become apparent from the description, the drawings, and the claims.

### BRIEF DESCRIPTION OF THE SEVERAL VIEWS OF THE DRAWINGS

FIG. 1 is a diagrammatic view of a location based meeting process coupled to a distributed computing network;

FIG. 2 is a flowchart of the location based meeting process of FIG. 1;

FIG. 3 is a meeting entry which may be associated with the location based meeting process of FIG. 1;

FIG. 4 is a calendar view that may be associated with the location based meeting process of FIG. 1;

FIG. 5 is a meeting invitation which may be associated with the location based meeting process of FIG. 1; and

FIG. 6 is a popup window which may be associated with the location based meeting process of FIG. 1.

### DETAILED DESCRIPTION OF THE INVENTION

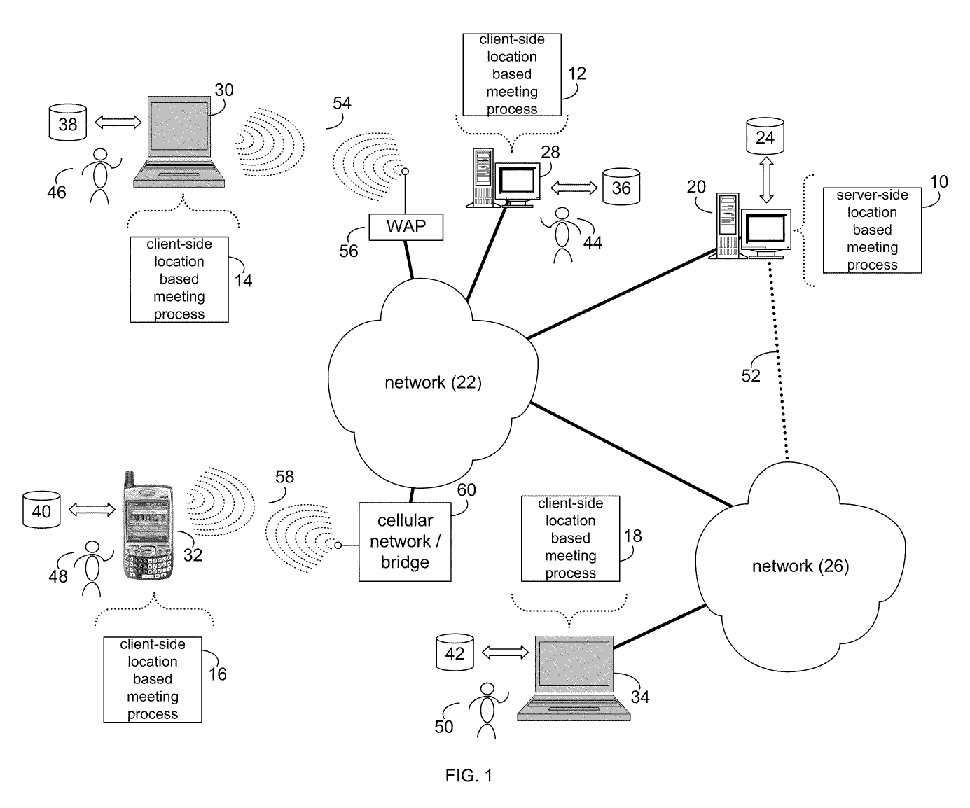

Referring to FIGS. 1 & 2, there is shown a location based meeting process 10. As will be discussed below, location based meeting process 10 may create 100 a local meeting entry, the local meeting entry referencing a global meeting entry in a different location. Location based meeting process may further propagate 102 a schedule change in the global meeting entry to the local meeting entry.

The location based meeting (LBM) process may be a server-side process (e.g., server-side LBM process 10), a client-side process (e.g., client-side LBM process 12, client-side LBM process 14, client-side LBM process 16, or client-side LBM process 18), or a hybrid server-side/client-side process (e.g., the combination of server-side LBM process 10 and one or more of client-side LBM processes 12, 14, 16, 18).

Server-side LBM process 10 may reside on and may be executed by server computer 20, which may be connected to network 22 (e.g., the Internet or a local area network). Examples of server computer 20 may include, but are not limited to: a personal computer, a server computer, a series of server computers, a mini computer, and/or a mainframe computer. Server computer 20 may be a web server (or a series of servers) running a network operating system, examples of which may include but are not limited to: Microsoft® Windows Server®; Novell® Netware®; or Red Hat® Linux®, for example.

The instruction sets and subroutines of server-side LBM process 10, which may be stored on storage device 24 coupled to server computer 20, may be executed by one or more processors (not shown) and one or more memory architectures (not shown) incorporated into server computer 20. Storage device 24 may include but is not limited to: a hard disk drive; a tape drive; an optical drive; a RAID array; a random access memory (RAM); and a read-only memory (ROM).

Server computer 20 may execute a web server application, examples of which may include but are not limited to: Microsoft® IIS, Novell® Web Server, or Apache® Web Server, that allows for access to server computer 20 (via network 22) using one or more protocols, examples of which may include but are not limited to HTTP (i.e., HyperText Transfer Protocol), SIP (i.e., session initiation protocol), and the Lotus® Sametime® VP protocol. Network 22 may be connected to one or more secondary networks (e.g., network 26), examples of which may include but are not limited to: a local area network; a wide area network; or an intranet, for example.

Client-side LBM processes 12, 14, 16, 18 may reside on and may be executed by client electronic devices 28, 30, 32, and/or 34 (respectively), examples of which may include but are not limited to personal computer 28, laptop computer 30, a data-enabled mobile telephone 32, notebook computer 34, personal digital assistant (not shown), smart phone (not shown) and a dedicated network device (not shown), for example. Client electronic devices 28, 30, 32, 34 may each be coupled to network 22 and/or network 26 and may each execute an operating system, examples of which may include but are not limited to Microsoft® Windows®, Microsoft Windows CE®, Red Hat® Linux®, or a custom operating system.

The instruction sets and subroutines of client-side LBM processes 12, 14, 16, 18, which may be stored on storage devices 36, 38, 40, 42 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Storage devices 36, 38, 40, 42 may include but are not limited to: hard disk drives; tape drives; optical drives; RAID arrays; random access memories (RAM); read-only memories (ROM); compact flash (CF) storage devices; secure digital (SD) storage devices; and memory stick storage devices.

Client-side LBM processes 12, 14, 16, 18 and/or server-side LBM process 10 may be processes that run within (i.e., are part of) a calendaring and scheduling application. Alternatively, client-side LBM processes 12, 14, 16, 18 and/or server-side LBM process 10 may be stand-alone applications that work in conjunction with the calendaring and scheduling application. One or more of client-side LBM processes 12, 14, 16, 18 and server-side LBM process 10 may interface with each other (via network 22 and/or network 26) to allow a plurality of users (e.g., users 44, 46, 48, 50) to share information. In one implementation client-side LBM processes 12, 14, 16, 18 and/or server-side LBM process 10 may be processes that run within Lotus® Notes®.

Users 44, 46, 48, 50 may access server-side LBM process 10 directly through the device on which the client-side LBM process (e.g., client-side LBM processes 12, 14, 16, 18) is executed, namely client electronic devices 28, 30, 32, 34, for example. Users 44, 46, 48, 50 may access server-side LBM process 10 directly through network 22 and/or through secondary network 26. Further, server computer 20 (i.e., the computer that executes server-side LBM process 10) may be connected to network 22 through secondary network 26, as illustrated with phantom link line 52.

The various client electronic devices may be directly or indirectly coupled to network 22 (or network 26). For example, personal computer 28 is shown directly coupled to network 22 via a hardwired network connection. Further, notebook computer 34 is shown directly coupled to network 26 via a hardwired network connection. Laptop computer 30 is shown wirelessly coupled to network 22 via wireless communication channel 54 established between laptop computer 30 and wireless access point (i.e., WAP) 56, which is shown directly coupled to network 22. WAP 56 may be, for example, an IEEE 802.11a, 802.11b, 802.11g, Wi-Fi, and/or Bluetooth device that is capable of establishing wireless communication channel 54 between laptop computer 30 and WAP 56. Data-enabled mobile telephone 32 is shown wirelessly coupled to network 22 via wireless communication channel 58 established between data-enabled mobile telephone 32 and cellular network/bridge 60, which is shown directly coupled to network 22.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### THE LOCATION BASED MEETING PROCESS

LBM process 10 may allow a user to create a location based copy of a meeting, which may be referred to as a local meeting entry. The local copy may respond to schedule changes in a global copy of the meeting, which may be referred to as a global meeting entry. For the following discussion, server-side LBM process 10 will be described for illustrative purposes. Client-side LBM process 12 may be incorporated into server-side LBM process 10 and may be executed within one or more applications that allow for communication with client-side LBM process 12. However, this is not intended to be a limitation of this disclosure, as other configurations are possible (e.g., stand-alone, client-side LBM processes and/or stand-alone server-side LBM processes.) For example, some implementations may include one or more of client-side LBM processes 14, 16, 18 in place of or in addition to client-side LBM process 12.

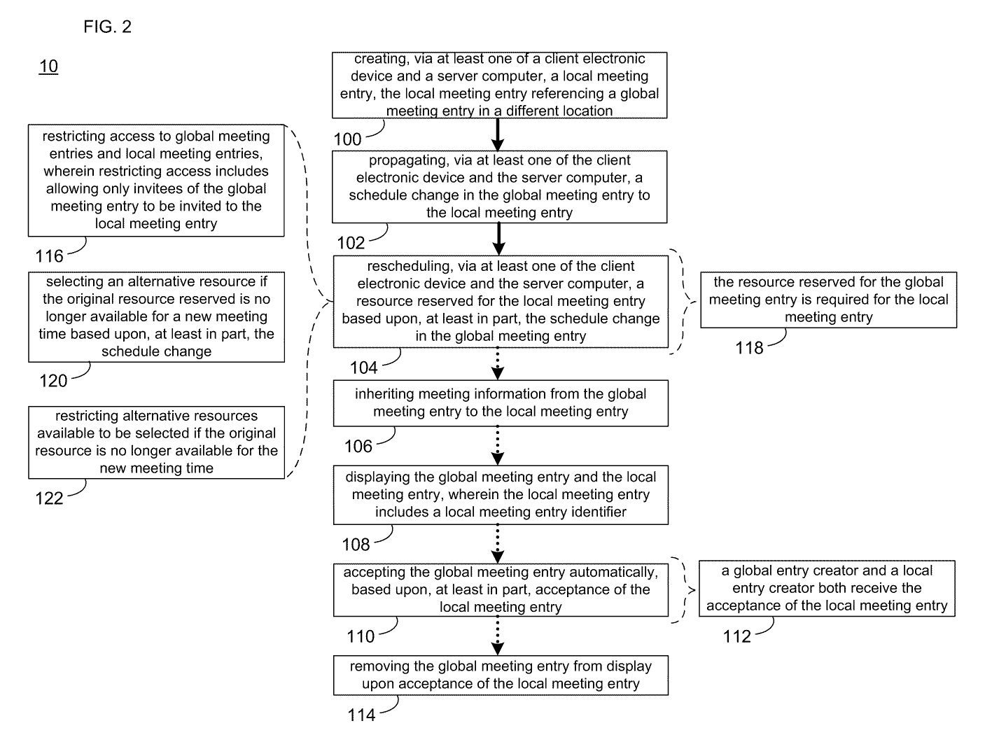

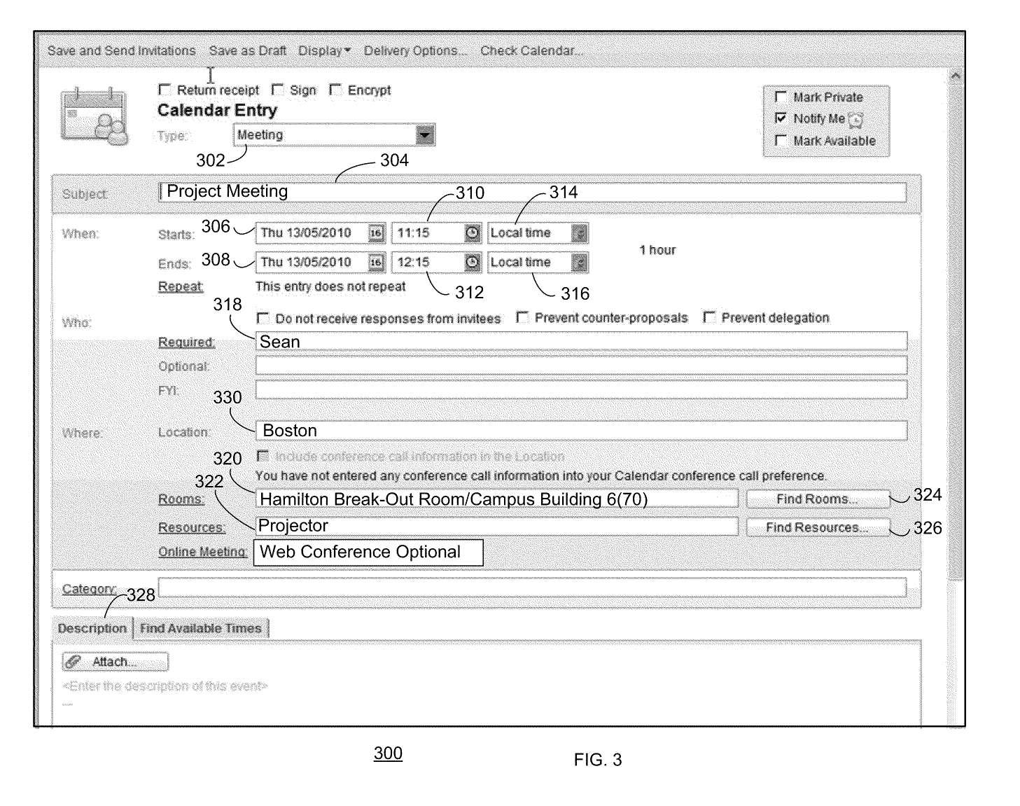

Referring now to FIGS. 1-6, LBM process 10 may create 100 local meeting entry 402. Local meeting entry 402 may reference global meeting entry 404 in a different location. For example, global meeting entry 404 may include meeting information (e.g., type field 302, subject field 304, start day field 306, end day field 308, location field 330, etc., as shown in FIG. 3) entered in calendar entry 300, which has location field 330 entered as “Boston” in this example. Local meeting entry 402 may have a location different than Boston, such as New York, for example. While local meeting entry 402 and global meeting entry 404 are discussed in this example as having different geographic locations, other configurations are possible. For example, global meeting entry 404 may have a location of “Boston-Server Facility”, and local meeting entry 402 may have a location of “Boston-Headquarters”. While these locations may not necessarily be different geographical locations, they may represent different locations at which meetings can take place. The term “different location” as used herein refers to a different physical location (i.e., different buildings, different facilities, etc.), not necessarily a different geographic location altogether.

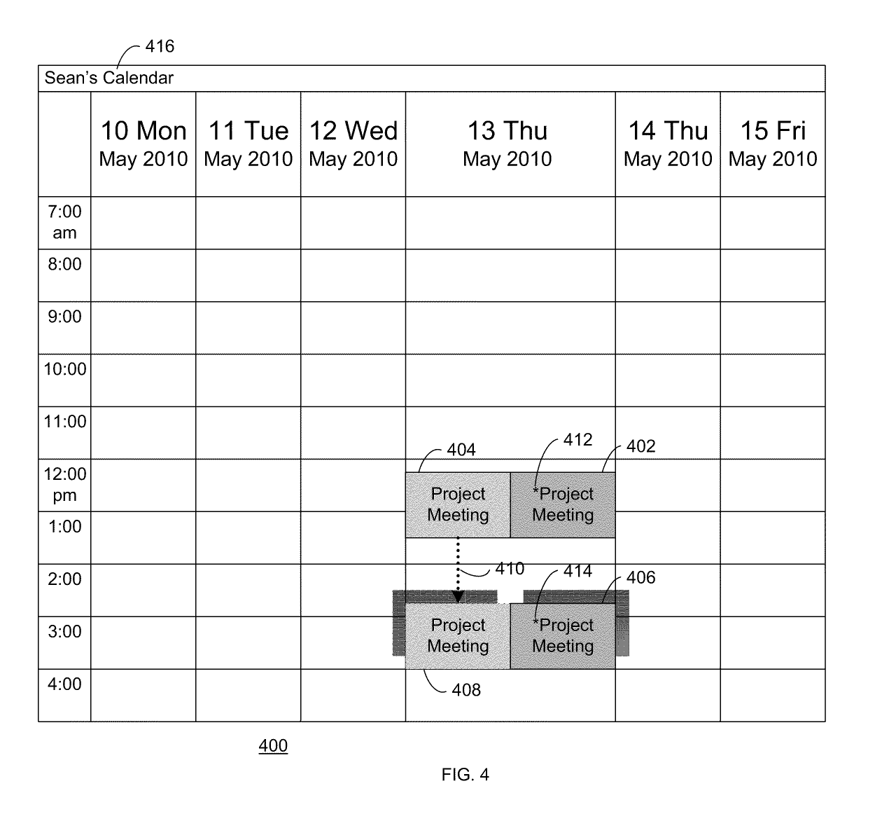

Calendar entry 300 may be a graphical user interface in which a user may create a global meeting entry and/or local meeting entry. When calendar entry 300 is sent to invitees, LBM process 10 may create global meeting entry 404, as shown in FIG. 4. Global meeting entry 404 may be viewed in calendar view 400 of a calendaring and scheduling program by each invitee. Global meeting entry 404 may include meeting information from calendar entry 300, entered by a user. Calendar entry 300 may have multiple fields which may be filled by a user in order to send out a meeting invitation. For example, a user may fill type field 302, subject field 304, start day field 306, end day field 308, start time field 310, end time field 312, time zone fields 314 and 316, required invitee field 318, location field 330, room field 320, resource field 322 and description field 328, as well as other information, all of which may be referred to collectively as “meeting information”. It should be noted that as discussed herein, the term “resource” may be used to describe both rooms (i.e., meeting rooms) and other resources (i.e., projectors, equipment, etc.).

Further, LBM process 10 may create local meeting entry 402, which may appear in a user's calendar view (e.g., user 416, shown as “Sean”) when calendar entry 300 is sent as an invitation. Location based meeting process 10 may display 108 global meeting entry 404 and local meeting entry 402 in calendar view 400. This may occur once calendar entry 300 is sent to invitees. Local meeting entry 402 may include local meeting entry identifier 412. While local meeting entry identifier 412 is shown as being an asterisk, other configurations are possible. For example, local meeting entry identifier 412 may be a different color, or an icon, or any other identifier capable of distinguishing local meeting entry 402 from global meeting entry 404.

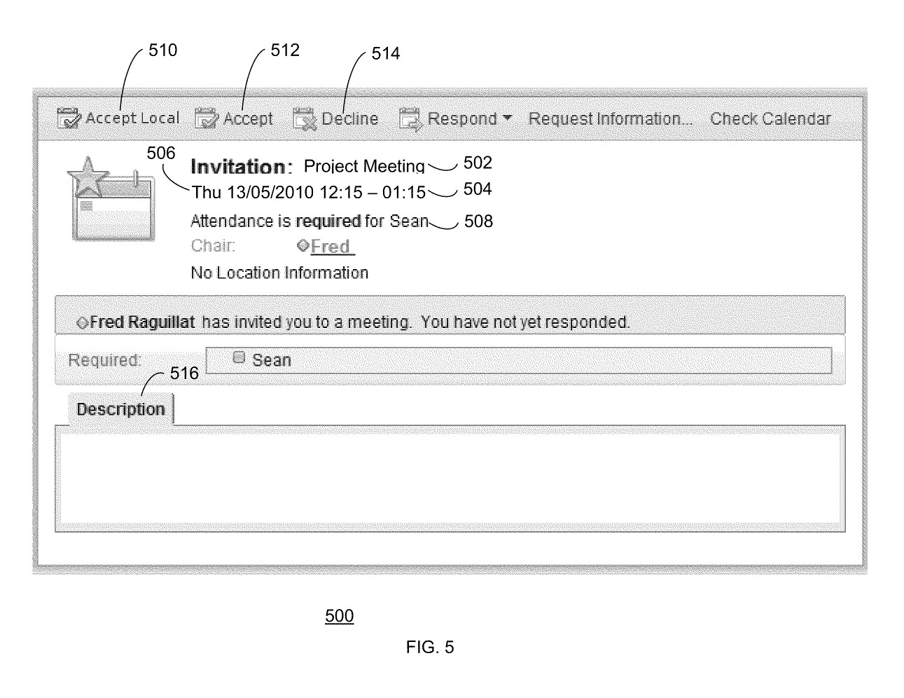

Once calendar entry 300 is sent to invitees as a meeting invitation, the invitees may receive global meeting entry 404. Invitees in a different location may also receive local meeting entry 402. Global meeting entry 404 and local meeting entry 402 may appear in both in each invitee's email inbox and as an entry in each invitee's calendar view (e.g., calendar view 400). Local meeting entry 402 may inherit 106 meeting information (e.g., type field 302, subject field 304, start day field 306, end day field 308, start time field 310, end time field 312, etc.), via LBM process 10, from global meeting entry 404. An invitee (e.g., required invitee Sean as shown in required invitee field 318) may open local meeting entry 402 from calendar view 400. As shown in FIG. 5, local meeting entry 402 and/or global meeting entry 404 may be viewed as invitation 500. Invitation 500 may include some of the information inherited by local meeting entry 402 from global meeting entry 404, including but not limited to subject field 302, start day field 306, start time field 310, and end time field 312, shown in FIG. 5 as subject indication 502, start day indication 506, and start/end time indication 504. The contents of required invitee field 318 may also be inherited, as shown by required invitee indication 508.

An invitee may accept invitation 500 by selecting either accept button 512 or accept local button 510 on invitation 500. Further, an invitee may decline invitation 500 by selecting decline button 500. If the invitee selects accept button 512, LBM process 10 may send an acceptance of invitation 500 to the sender (e.g., the global meeting entry creator) of invitation 500. The acceptance may be an acceptance of the invitation for global meeting entry 404. If the invitee selects accept local meeting button 510, LBM process 10 may send an acceptance of the invitation for local meeting entry 402. LBM process 10 may automatically accept 110 global meeting entry 404, based upon, at least in part, the acceptance of local meeting entry 402.

For example, assume Fred sends out calendar entry 300 as a meeting invitation to invitee Sean, as shown in required invitee field 318. Further, assume Fred is in Boston (as indicated by location field 330), and that Sean is in another location, e.g., New York. Sean may receive the meeting invitation in one or more of his email inbox and calendar view (e.g., calendar view 400) in his calendaring and scheduling application (e.g., Lotus® Notes®). Since Fred and Sean are in different locations, both global meeting entry 404 and local meeting entry 402 may appear in his calendar view. Sean may open local meeting entry 402 directly from Sean's calendar view (e.g., calendar view 400) and may view invitation 500. If Sean wishes to attend the meeting locally, he may select accept local button 510. LBM process 10 may then automatically accept 110 global meeting entry 404, based upon, at least in part, Sean's acceptance of local meeting entry 402. Further, local meeting entry 402 may be dynamically updated based upon, at least in part a location (not shown) of local meeting entry 402. If, for example, local meeting entry 402 has a location of New York (e.g., Sean's location), LBM process 10 may update the location of local meeting entry 402 to reflect that the location is New York.

Since Fred created calendar entry 300 and selected the required invitees for this meeting, he may be the chair, host, and/or organizer of calendar entry 300. The chair, host, and/or organizer of calendar entry 300 may be referred to as the global meeting entry creator. Further, assume for illustrative purposes that Sean selected accept local button 510. Sean may be the first invitee to have accepted invitation 500 from his location (e.g., New York). Further, Sean may wish to invite others at the New York location to the local meeting. Sean may become the chair, host, and/or organizer of the local meeting associated with calendar entry 300, and may be referred to as the local meeting entry creator. Upon Sean's acceptance of the local meeting invitation (e.g., invitation 500), the global meeting entry creator (e.g., Fred) and the local meeting entry creator (e.g., Sean) may both receive (112) the acceptance of local meeting entry 402. Both the global meeting entry creator and the local meeting entry creator may receive the acceptance in their email inboxes, respectively. The global meeting entry may indicate and/or list each invitee that has accepted the invitation. In this way, the global meeting entry creator may see the full list of participants across each location.

Further, LBM process 10 may notify the global meeting entry creator (e.g., Fred) if one or more situations occur. These situations may include, but are not limited to, if the local meeting entry creator (e.g., Sean) declines local meeting entry 402, if the local meeting entry creator (e.g,. Sean) delegates local meeting entry 402, and/or if local meeting entry 402 is not scheduled. For example, the local meeting entry creator (e.g., Sean) may decline local meeting entry 402 by selecting decline button 514 on invitation 500. Further, the local meeting entry creator (e.g., Sean) may delegate local meeting entry 402 to another invitee and/or user, who may then become the local meeting entry creator. This option may be available in a calendaring and scheduling application running in conjunction with LBM process 10. In one example, Fred may have selected Sean to be the local meeting entry creator, and Sean may have delegated local meeting entry 402 to another invitee and/or user. Further, local meeting entry 402 may not be scheduled, if, for example, none of the invitees of local meeting entry 402 accept local meeting entry 402.

Assume now for illustrative purposes that Fred invited, in addition to Sean, Jane of the New York location when sending out calendar entry 300. Further assume that Fred also invited Dirk and Jim from a Philadelphia location. Jane may select the accept local button (which may be similar to accept local button 510) on her invitation (which may be similar to invitation 500) before Sean. Jane may now be the chair, host, and/or organizer of the meeting for the New York location, and may be referred to as the local meeting entry creator (for, e.g., the New York location). Additionally, Dirk may select the accept local button (which may be similar to accept local button 510) on his invitation (which may be similar to invitation 500) before Jim. Dirk may now be the chair, host, and/or organizer of the meeting for the Philadelphia location, and may be referred to as the local meeting entry creator (for, e.g., the Philadelphia location). Alternatively, the local meeting entry creator may be specified, for example, by the global meeting entry creator. As local meeting entry creators for the New York location and the Philadelphia location, respectively, Jane and Dirk may invite other local colleagues. LBM process 10 may restrict 116 access to global meeting entries and local meeting entries. In other words, LBM process 10 may not allow certain people in the New York location and/or Philadelphia location to be invited to the meeting. This restriction may be based upon, at least in part, restrictions entered by the global meeting entry creator. For example, restricting 116 access may include allowing only invitees (e.g., those in required invitee field 318) of global meeting entry 404 to be invited to local meeting entry 402. Further, notification may be sent to the global meeting entry creator and/or host when more local invitees are invited.

Upon acceptance of local meeting entry 402 (by, e.g., Sean), LBM process 10 may remove 114 global meeting entry 404 from display. In other words, global meeting entry 404 may no longer appear in calendar view 400. Further, assume that Sean is the local meeting entry creator for the Boston location. Sean may now need to select a meeting room and/or other resources for the meeting. Upon opening local meeting entry 402, LBM process 10 may render, for the local meeting entry creator, a graphical user interface and/or popup window including fields similar to those in calendar entry 300, which may allow Sean to search for and select local resources for the meeting.

Assume for exemplary purposes that Fred, the global meeting entry creator, decides to change the meeting time. As shown in calendar entry 300 the meeting may be scheduled to start at 11:15 (as indicated by start time field 310). Further, the meeting may be scheduled to end at 12:15 (as indicated by end time field 312). Fred may decide that the meeting time should change from 11:15-12:15 to 2:45-4:00, and may change (not shown) the start time to 2:45 and end time to 4:00 in calendar entry 300, via start time field 310 and end time field 312. LBM process 10 may update global meeting entry 404 in calendar view 400 to reflect the schedule change (as indicated by dashed-line 410 in FIG. 4). LBM process 10 may further propagate 102 a schedule change (as indicated by dashed-line 410) in global meeting entry 404 to local meeting entry 402. As shown in FIG. 4, LBM process 10 may adjust global meeting entry 404 to reflect the schedule change, as indicated by global meeting entry 408. Further, LBM process 10 may adjust local meeting entry 402 to reflect the schedule change, as indicated by local meeting entry 406. Local meeting entry 406 may include local meeting entry identifier 414. Once the schedule change has been reflected in calendar view 400, global meeting entry 404 and local meeting entry 402, which indicate the original meeting time, may be removed from display by LBM process 10.

The global meeting entry creator may decide to change other meeting information as well. For example, the global meeting entry creator may change the contents of subject field 304 and/or description field 328 through calendar entry 300. LBM process 10 may propagate changes to subject field 304 and/or description field 328 from calendar entry 300 to global meeting entry 408 and also to local meeting entry 406.

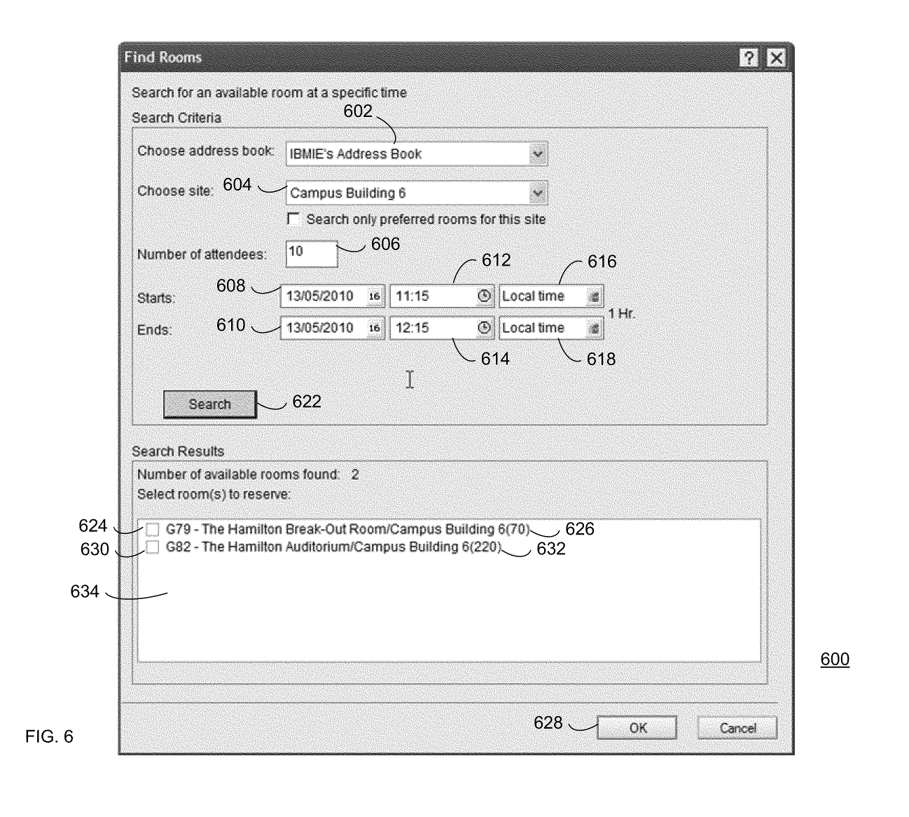

Referring back to FIG. 3, a meeting room may be selected by the user creating calendar entry 300 (e.g., Fred in this example). For example, the user may select find rooms button 324, which may cause LBM process 10 to render find rooms popup 600. Find rooms popup 600 may include choose address book dropdown menu 602, choose site dropdown menu 604, and number of attendees field 606. Further, find rooms popup window 600 may inherit information in start day field 306, end day field 308, start time field 310, and end time 312 from calendar entry 300, as shown by start day field 608, end day field 610, start time field 612, and end time field 614 in FIG. 6. Find rooms popup window 600 may also inherit time zone fields 314 and 316 from calendar entry 300, as shown by time zone fields 616 and 618. The user may also change any of the above meeting information in find rooms popup 600, and LBM process 10 may reflect these changes in calendar entry 300. Using address book dropdown menu 602, choose site dropdown menu 604, and number of attendees field 606, the user may choose an address book, site, and number of attendees.

Continuing with the above example, while not shown in find rooms popup window 600, the user (e.g., Fred) may select a “Boston” address book and may choose a “server facility” site. The user, who may be the global meeting entry creator, may then select search button 622 and execute a search to find a meeting room, based upon, at least in part, the meeting information entered and/or inherited in find rooms popup window 600. Find rooms popup window 600 may display search results 634 in response to executing the search. Search results 634 may include a number of rooms available, including but not limited to meeting rooms 626 and 632, respectively. The user may select meeting room 626 by selecting checkbox 624, and selecting “OK” button 628.

Other resources besides meeting rooms may be required for meetings. Various equipment such as a projector, computer, television, speaker system, and/or teleconferencing system may need to be reserved for a meeting. One or more of these resources may be reserved through calendar entry 300 for the global meeting. The resource reserved (e.g., a projector as indicated by resource field 322) for global meeting entry 404 may be required 118 for local meeting entry 402. As shown in calendar entry 300, the user (e.g., Fred) may select find resources button 326, which may render a find resources popup window (not shown) similar to find rooms popup window 600. Based upon, at least in part, meeting information entered by the user and/or inherited from calendar entry 300 and/or global meeting entry 404 in the find resources popup window, LBM process 10 may list a number of resources other than meeting rooms (e.g., a projector, a computer, a television, a speaker system, and/or a teleconferencing system) which may be selected by the user. The global meeting entry creator may mandate one or more resources required for the meeting and may have those resources imposed on all local meeting entries.

Assume for illustrative purposes that LBM process 10 rendered a popup window similar to find rooms popup window 600 for the local meeting entry creator (e.g., Sean). Further assume that Sean selected a room based upon the original meeting time of 11:15-12:15, and that the global meeting entry creator, e.g., Fred, changed the meeting time as discussed above to 2:45-4:00. LBM process 10 may reschedule 104 a resource reserved (e.g., meeting room 626, reserved for the local meeting in this example) for local meeting entry 406 based upon, at least in part, the schedule change (as indicated by dashed-line 410) in global meeting entry 404. For example, assume a popup window similar to find rooms popup window 600 was rendered by LBM process 10 for the local meeting entry creator (e.g., Sean), and that meeting room 626 was selected for the local meeting room. If the global meeting entry creator (e.g., Fred) changes the schedule of the meeting from 11:15-12:15 to 2:45-4:00, as discussed above, LBM process 10 may reschedule 104 a resource reserved (e.g., meeting room 626) for local meeting entry 406 based upon, at least in part, the schedule change (as indicated by dashed-line 410) in global meeting entry 404. This rescheduling may ensure that meeting room 626 is available for the local meeting at the changed time.

In some situations, a schedule change such as the one described above may cause a reserved resource (e.g., meeting room 626 and/or a projector) to be unavailable for the meeting. Continuing with the above example, assume that meeting room 626 was available during the original scheduled time (i.e., 11:15-12:15) for the local meeting, but is not available at the new scheduled time (i.e., 2:45-4:00). Further, assume that meeting room 632 is available for the local meeting at the new scheduled time (i.e., 2:45-4:00). LBM process 10 may select 120 an alternative resource (e.g., meeting room 632) if the original resource reserved (e.g., meeting room 626) is no longer available for a new meeting time (i.e., 2:45-4:00 in this example) based upon, at least in part, the schedule change (indicated by dashed line 410). While LBM process 10 may automatically select the alternative resource (e.g., meeting room 632), a user (e.g., Sean) may also select the alternative resource. Once the schedule has changed in calendar entry 300 and/or global meeting entry 404, one or more of the global meeting entry creator and the local meeting entry creator(s) may be prompted to choose an alternative resource because the originally scheduled resource may no longer be available. Propagation of schedule changes from global meeting entries to local meeting entries by LBM process 10 may be handled by a local host of a calendaring and scheduling application that may run LBM process 10. In this way, conflicts for resources such as meeting rooms and projectors may be resolved by the local host.

In some situations, LBM process 10 may restrict 122 alternative resources available (e.g., meeting room 632) to be selected if the original resource (e.g., meeting room 626) is no longer available for the new meeting time (i.e., 2:45-4:00 in this example). For example, and as shown in FIG. 6, the alternative resources available may include an important room, e.g., meeting room 632, which may be an auditorium, board room, or other room in high demand. LBM process 10 may be configured such that important rooms are not automatically selected as alternative resources. Further, LBM process 10 may also be configured such that important rooms are not selectable as alternatives for users, e.g., global meeting entry creators and/or local meeting entry creators. LBM process 10 may also be configured such that rooms which are unsuitable for a meeting are not selectable. Rooms may be unsuitable if, for example, they are too small, have insufficient equipment, or are not in good enough condition for a meeting.

In one embodiment, calendar entry 300 may include a hidden field (not shown) which may include references to all direct local copies (e.g., all local meeting entries). Updates to the global meeting entry may be propagated to all users who directly accepted an invitation associated with the global meeting entry, and also may be propagated to each local meeting entry. Local meeting entries may then be automatically processed and updates to the global meeting entry may be propagated to users who directly accepted a local meeting entry. The automatic processing of these updates may be carried out by LBM process 10, which may run on e.g., a Domino® server. Further, the features described in the present disclosure may apply to other options in calendaring and scheduling applications. For example the features described may carry forward to meeting repeats, meeting delegation, centralized references to web conferences, or other meeting resources.

As will be appreciated by one skilled in the art, aspects of the present invention may be embodied as a system, apparatus, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (i.e., a client electronic device), partly on the user's computer, as a stand-alone software package, partly on the user's computer and partly on a remote computer or entirely on the remote computer or server (i.e., a server computer). In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and/or computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures may illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Further, one or more blocks shown in the block diagrams and/or flowchart illustration may not be performed in some implementations or may not be required in some implementations. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

A number of embodiments and implementations have been described.

Nevertheless, it will be understood that various modifications may be made. Accordingly, other embodiments and implementations are within the scope of the following claims.

What is claimed is:

1. A method comprising:
creating, via at least one of a client electronic device and a server computer, a local meeting entry, the local meeting entry referencing a global meeting entry in a different location;
propagating, via at least one of the client electronic device and the server computer, a schedule change in the global meeting entry to the local meeting entry; and
rescheduling, via at least one of the client electronic device and the server computer, a resource reserved for the local meeting entry based upon, at least in part, the schedule change in the global meeting entry.

2. The method of claim 1, further comprising:
inheriting meeting information from the global meeting entry to the local meeting entry.

3. The method of claim 1, further comprising:
displaying the global meeting entry and the local meeting entry, wherein the local meeting entry includes a local meeting entry identifier.

4. The method of claim 3, further comprising:
accepting the global meeting entry automatically, based upon, at least in part, acceptance of the local meeting entry.

5. The method of claim 4, wherein a global meeting entry creator and a local meeting entry creator both receive the acceptance of the local meeting entry.

6. The method of claim 4, further comprising;
removing the global meeting entry from display upon acceptance of the local meeting entry.

7. The method of claim 1, further comprising;
restricting access to global meeting entries and local meeting entries, wherein restricting access includes allowing only invitees of the global meeting entry to be invited to the local meeting entry.

8. The method of claim 1, wherein the resource reserved for the global meeting entry is required for the local meeting entry.

9. The method of claim 1 further comprising:
selecting an alternative resource if the original resource reserved is no longer available for a new meeting time based upon, at least in part, the schedule change.

10. The method of claim 1 further comprising:
restricting alternative resources available to be selected if the original resource is no longer available for the new meeting time.

11. The method of claim 1, further comprising:
dynamically updating the local meeting entry based upon, at least in part, a location of the local meeting entry.

12. The method of claim 1, further comprising:
notifying a global meeting entry creator if at least one of:
a local meeting entry creator declines the local meeting entry;
the local meeting entry creator delegates the local meeting entry; and
the local meeting entry is not scheduled.

13. A computer program product residing on a computer readable storage medium having a plurality of instructions stored thereon, which, when executed by a processor, cause the processor to perform operations comprising:
creating the local meeting entry referencing a global meeting entry in a different location;
propagating a schedule change in the global meeting entry to the local meeting entry; and
rescheduling a resource reserved for the local meeting entry based upon, at least in part, the schedule change in the global meeting entry.

14. The computer program product of claim 13, further comprising instructions for:
inheriting meeting information from the global meeting entry to the local meeting entry.

15. The computer program product of claim 13, further comprising instructions for:
displaying the global meeting entry and the local meeting entry, wherein the local meeting entry includes a local meeting entry identifier.

16. The computer program product of claim 13, further comprising instructions for:
accepting the global meeting entry automatically, based upon, at least in part, acceptance of the local meeting entry.

17. The computer program product of claim 16, wherein a global meeting entry creator and a local meeting entry creator both receive the acceptance of the local meeting entry.

18. The computer program product of claim 16, further comprising instructions for:
removing the global meeting entry from display upon acceptance of the local meeting entry.

19. The computer program product of claim 13, further comprising instructions for:
restricting access to global meeting entries and local meeting entries, wherein restricting access includes allowing only invitees of the global meeting entry to be invited to the local meeting entry.

20. The computer program product of claim 13, wherein the resource reserved for the global meeting entry is required for the local meeting entry.

21. The computer program product of claim 13, further comprising instructions for:
selecting an alternative resource if the original resource reserved is no longer available for a new meeting time based upon, at least in part, the schedule change.

22. The computer program product of claim 13, further comprising instructions for:
restricting alternative resources available to be selected if the original resource is no longer available for the new meeting time.

23. The computer program product of claim 13, further comprising instructions for:
dynamically updating the local meeting entry based upon, at least in part, a location of the local meeting entry.

24. The computer program product of claim 13, further comprising instructions for:
notifying a global meeting entry creator if at least one of:
a local meeting entry creator declines the local meeting entry;
the local meeting entry creator delegates the local meeting entry; and
the local meeting entry is not scheduled.
